(19) United States
(12) Patent Application Publication
(10) Pub. No.: US 2012/0167728 A1
(43) Pub. Date: Jul. 5, 2012

(54) Locking Pliers with Fall Arrest Anchoring Device

(76) Inventor: Artemio Miramontes, Santa Ana, CA (US)

(21) Appl. No.: 13/330,291

(22) Filed: Dec. 19, 2011

Related U.S. Application Data
(60) Provisional application No. 61/429,279, filed on Jan. 3, 2011.

(51) Int. Cl. A62B 35/00; B25B 7/02; B25B 7/14

(52) U.S. Cl. 81/324

(57) ABSTRACT

A locking pliers with a punch for purposes of arresting a fall by a worker from a structure is disclosed. The locking pliers have at least two opposing gripping surfaces. One surface has a punch and the opposing surface has a slot for receiving the punch. The locking pliers are affixed to a suitable support structure, such as flashing on a roof. The punch creates a hole in the flashing securing the locking pliers to the flashing. The locking pliers include means for attachment of a lanyard. The lanyard is attached to a worker to limit the distance the worker can fall in the event of an accident.

### PRIORITY

Priority is claimed based on the Jan. 3, 2011 filing of provisional application 61/429,279, said application being specifically incorporated herewith in its entirety by reference for all purposes.

### BACKGROUND OF INVENTION

This invention relates to a new locking pliers with a punch incorporated into the plier jaw for purposes of use as an anchorage for preventing a fall from a structure.

A high percentage of fatalities while working on a construction site are from falls. Occupational Safety and Health Administration regulations require safety precautions when workers work above certain specified heights. Safety harnesses are one type of safety device used to protect workers and to comply with OSHA regulations. A safety harness often requires some means for providing an anchorage to the structure, with a lanyard running from the anchorage point to the harness being worn by the worker.

Many safety systems have been developed to protect workers, such as painters, construction workers and roofers, while working on steep roofs or on structures were a fall could prove hazardous. Most systems require an anchor attached to either a rafter of a truss or to the surface of the roof. These anchor systems may be temporary or permanent. While many systems are available, even a casual observation of actual working conditions shows that safety rules regarding fall protective devices and safe construction practices are often ignored, especially in the residential setting. Reasons for this include the systems being too time consuming to install, the systems being too restrictive of worker movement, and the systems being too difficult to install for the particular job conditions. The present invention relates to a simple and universal anchoring system for a safety harness that is easily installed at almost every construction site.

### BRIEF DESCRIPTION OF THE DRAWINGS

FIG. 1 contains a parametric view of a Locking Pliers with Fall Arrest Anchoring Device according to the preferred embodiment of the present invention.

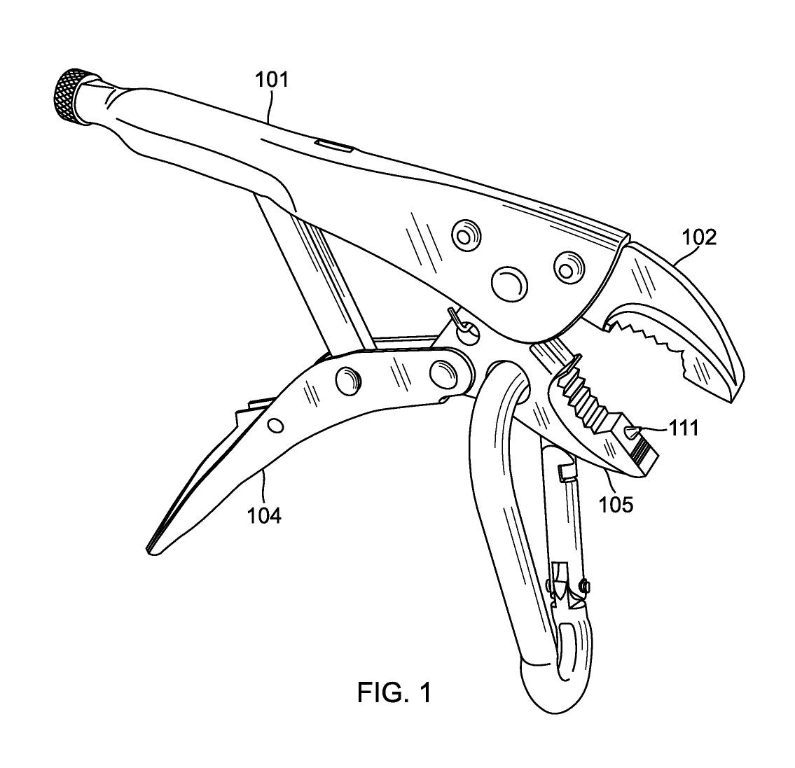

FIG. 2 contains a parametric view of a Locking Pliers with Fall Arrest Anchoring Device according to the preferred embodiment of the present invention.

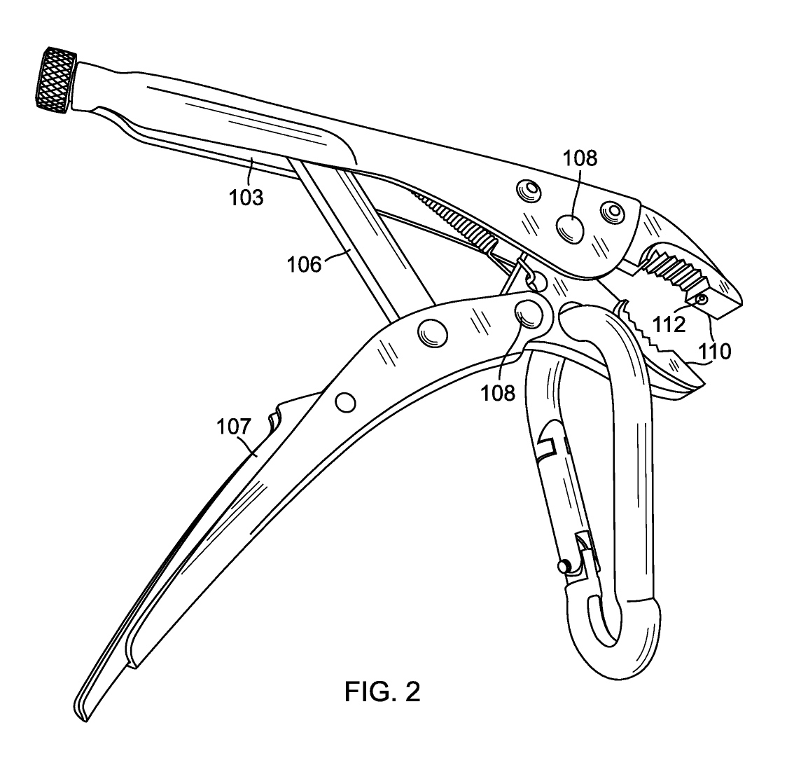

FIG. 3 contains a parametric view of a Locking Pliers with Fall Arrest Anchoring Device according to the preferred embodiment of the present invention.

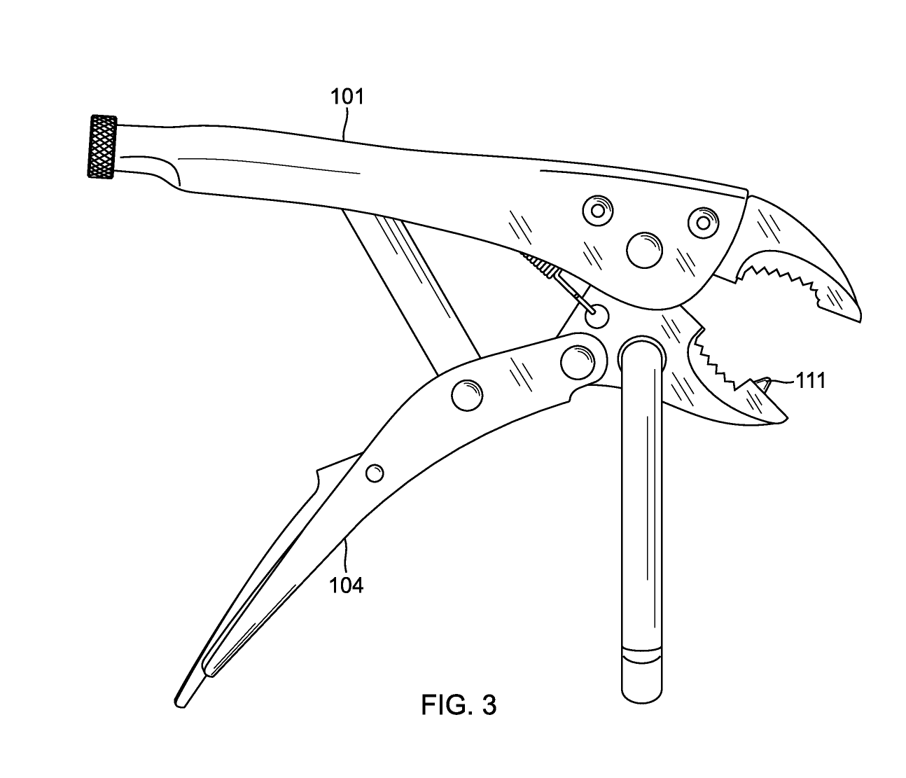

FIG. 4 contains a parametric view of a Locking Pliers with Fall Arrest Anchoring Device according to an alternative embodiment of the present invention.

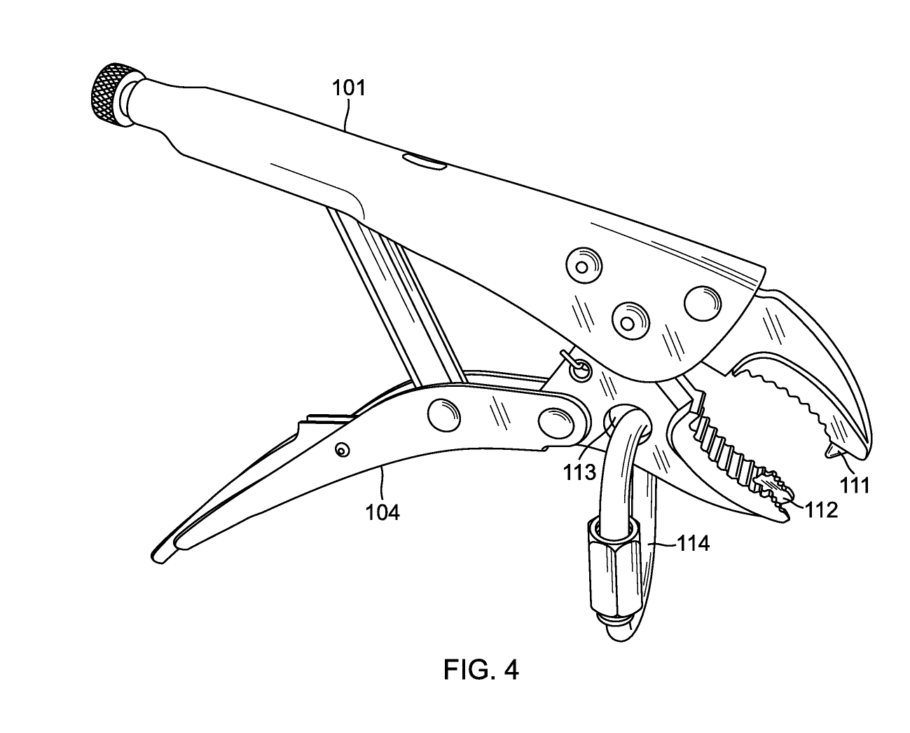

FIG. 5 contains a parametric view of a Locking Pliers with Fall Arrest Anchoring Device according to an alternative embodiment of the present invention.

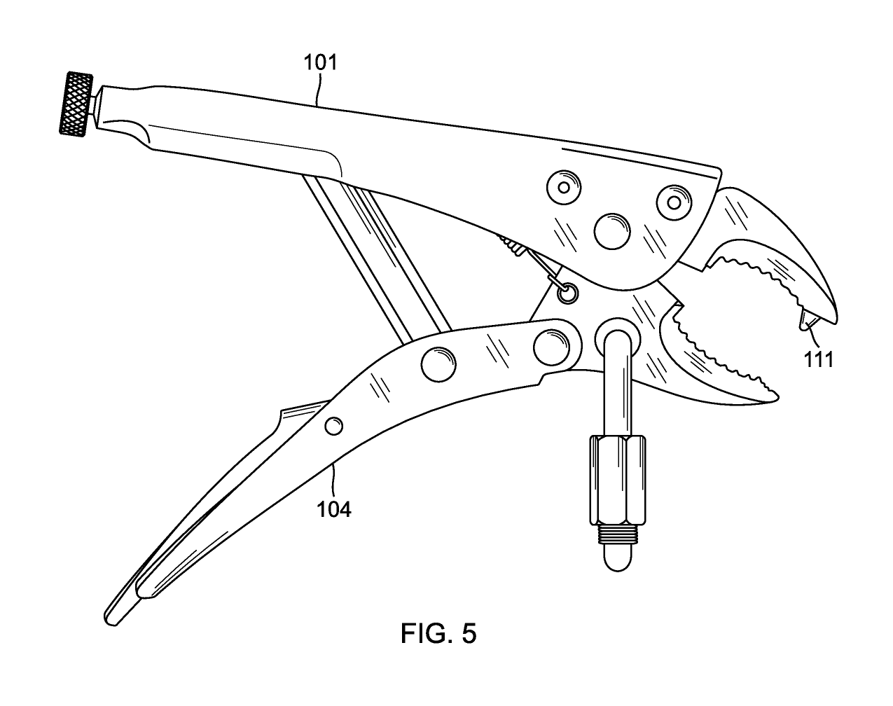

FIG. 6 contains a parametric view of a Locking Pliers with Fall Arrest Anchoring Device according to an alternative embodiment of the present invention.

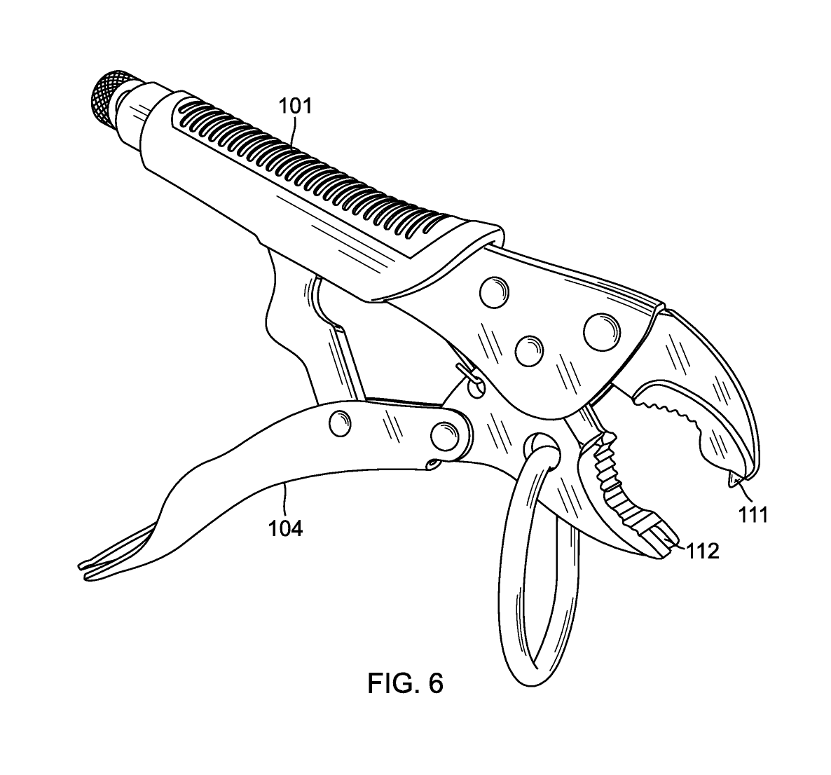

FIG. 7 contains a parametric view of a Locking Pliers with Fall Arrest Anchoring Device according to an alternative embodiment of the present invention.

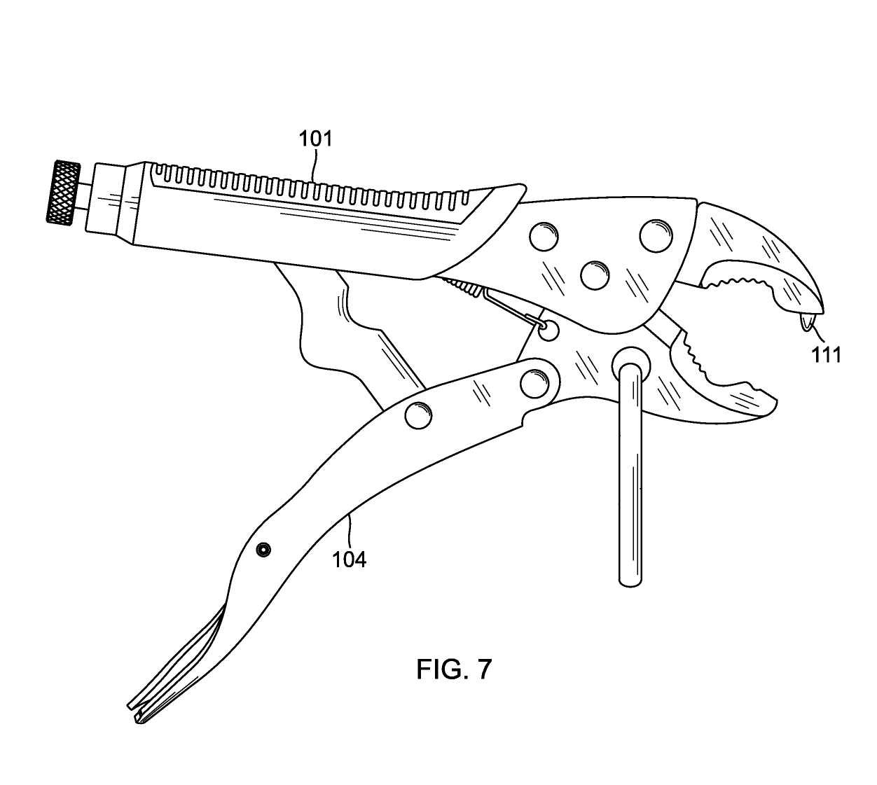

### DETAILED DESCRIPTION OF INVENTION

Locking pliers, such as the brand VISE-GRIP, are well known in the construction trade, and are almost universally carried in every construction worker's tool box. They generally comprise a stationary handle, with the distal end of the stationary handle defining a fixed jaw and a proximal end defining a hollow adjustment barrel. The locking pliers also include an operating handle with a moveable jaw. The movable jaw is pivotable to the stationary handle in cooperation with the fixed jaw. The operating handle is used to lock the pliers. A release lever is pivotable to the operating handle for selectively releasing the pliers. In some locking pliers the operating handle serves the function of releasing the plies as well as locking them.

The present invention relates to a new design of a locking pliers that can serve as an anchoring point for a safety harness system. The locking pliers offer a secure hold, and can be quickly installed and released with minimal effort. The present invention comprises a locking pliers with a punch. The punch is comprised of a punch head and a corresponding slot or other opening for receiving the punch head.

They present invention comprises a locking pliers that includes a stationary handle (101), with the distal end of the stationary handle defining a fixed jaw (102), and a proximal end defining a hollow adjustment barrel (103). The locking pliers also includes an operating handle (104) with a moveable jaw (105). The movable jaw is pivotable to the stationary handle in cooperation with the fixed jaw. The operating handle is capable of locking the pliers by locking means (106), such as a lever mechanism used in VISE-GRIP pliers. A release lever (107) is pivotable to the operating handle for selectively releasing the pliers. The first jaw is fixed and the second jaw is movable around pivot points. (108) Each jaw has a proximal end (109) and a distal end (110), with the proximal end being closest to the pivot point and the distal end furthest. The distal end of the jaw is shaped to provide means for gripping an object.

The jaws incorporate a punch head. (111) The punch head can be incorporated into either the movable jaw or the fixed jaw. The jaw surface opposing the punch head is constructed with an opening (112) to receive the punch head. Even though the jaw includes a punch head, the locking pliers can still perform the intended function of firmly gripping an object. In the preferred embodiment, the punch head is an elongated bar which is conically shaped, tooth-like and pointed, for easily puncturing metal window frames, flashing, chimney caps, roof jacks or other metal anchorage points. The length of the punch head corresponds with the thickness of the opposing jaw. Of course, other shapes and dimensions would be appreciated by those skilled in the field and the shape and length of the punch head may be selected as the needs dictate. The punch head and corresponding slot may be located at the proximal end or the distal end of the jaws or anywhere along the gripping surface.

The locking pliers as described in the invention may also include a hole (113) for purposes of attaching to a lanyard. In the preferred embodiment, a lobster claw ring (114) is attached to the hole to allow for easier attachment of the lanyard and for pivoting of the lanyard around the locking pliers. Alternative embodiments include split rings and J hooks.

One method of using the present invention would be to locate a suitable attachment point, such as an aluminum member of a window frame or flashing. Next the locking pliers would be positioned such that when engaged, the punch head will create a hole through the metal frame, locking the pliers to the frame. A lanyard can be attached to the ring on the locking pliers and run to a connection on a harness worn by the construction worker. Other methods of use would be obvious to those skilled in the industry.

I claim:

1. A Locking Pliers with Fall Arrest Anchoring Device comprising:
a stationary handle with proximal and distal ends, the distal end of the stationary handle defining a fixed jaw;
an operating handle with proximal and distal ends, the distal end defining a moveable jaw, the movable jaw being pivotable to the stationary handle around a pivot point;
a locking means capable of locking the stationary handle and operating handle in a fixed position;
the moveable jaw having a proximal end and a distal end, the proximal end being closest to the pivot point and the distal end furthest from the pivot point,
a punch head projecting from the proximal end of the moveable jaw;
the fixed jaw having a proximal end and a distal end, the proximal end being closest to the pivot point and the distal end furthest from the pivot point, the proximal end defining an opening for receiving the punch head.

2. The Locking Pliers with Fall Arrest Anchoring Device of claim 1, wherein the punch head projects from the distal end of the moveable jaw, and the distal end of the fixed jaw defines an opening for receiving the punch head.

3. The Locking Pliers with Fall Arrest Anchoring Device of claim 1, wherein the punch head projects from the proximal end of the fixed jaw, and the proximal end of the moveable jaw defines an opening for receiving the punch head.

4. The Locking Pliers with Fall Arrest Anchoring Device of claim 1, wherein the punch head projects from the distal end of the fixed jaw, and the distal end of the moveable jaw defines an opening for receiving the punch head.

5. A Locking Pliers with Fall Arrest Anchoring Device comprising:
a stationary handle with proximal and distal ends, the distal end of the stationary handle defining a fixed jaw;
an operating handle with proximal and distal ends, the distal end defining a moveable jaw, the movable jaw being pivotable to the stationary handle around a pivot point;
locking means capable of locking the stationary handle and operating handle in a fixed position;
the moveable jaw having a proximal end and a distal end, the proximal end being closest to the pivot point and the distal end furthest from the pivot point,
a punch head projecting from the proximal end of the moveable jaw;
the fixed jaw having a proximal end and a distal end, the proximal end being closest to the pivot point and the distal end furthest from the pivot point, the proximal end defining an opening for receiving the punch head;
the moveable jaw defining a hole for an attachment point for a lanyard.

6. The Locking Pliers with Fall Arrest Anchoring Device of claim 5, wherein the punch head projects from the distal end of the moveable jaw, and the distal end of the fixed jaw defines an opening for receiving the punch head.

7. The Locking Pliers with Fall Arrest Anchoring Device of claim 5, wherein the punch head projects from the proximal end of the fixed jaw, and the proximal end of the moveable jaw defines an opening for receiving the punch head.

8. The Locking Pliers with Fall Arrest Anchoring Device of claim 5, wherein the punch head projects from the distal end of the fixed jaw, and the distal end of the moveable jaw defines an opening for receiving the punch head.

9. A Locking Pliers with Fall Arrest Anchoring Device comprising:
a stationary handle with proximal and distal ends, the distal end of the stationary handle defining a fixed jaw;
an operating handle with proximal and distal ends, the distal end defining a moveable jaw, the movable jaw being pivotable to the stationary handle around a pivot point;
locking means capable of locking the stationary handle and operating handle in a fixed position;
the moveable jaw having a proximal end and a distal end, the proximal end being closest to the pivot point and the distal end furthest from the pivot point,
a punch head projecting from the proximal end of the moveable jaw;
the fixed jaw having a proximal end and a distal end, the proximal end being closest to the pivot point and the distal end furthest from the pivot point, the proximal end defining an opening for receiving the punch head;
the fixed jaw defining a hole for an attachment point for a lanyard.

10. The Locking Pliers with Fall Arrest Anchoring Device of claim 9, wherein the punch head projects from the distal end of the moveable jaw, and the distal end of the fixed jaw defines an opening for receiving the punch head.

11. The Locking Pliers with Fall Arrest Anchoring Device of claim 9, wherein the punch head projects from the proximal end of the fixed jaw, and the proximal end of the moveable jaw defines an opening for receiving the punch head.

12. The Locking Pliers with Fall Arrest Anchoring Device of claim 9, wherein the punch head projects from the distal end of the fixed jaw, and the distal end of the moveable jaw defines an opening for receiving the punch head.

13. A Locking Pliers with Fall Arrest Anchoring Device comprising:
a locking pliers with a fixed jaw and a jaw moveable around a pivot point;
the moveable jaw have a proximal and a distal end,
a punch head projecting from the proximal end of the moveable jaw;
the fixed jaw having a proximal and distal end, the proximal end defining an opening for receiving the punch head.

14. The Locking Pliers with Fall Arrest Anchoring Device of claim 13, wherein the punch head projects from the distal end of the moveable jaw, and the distal end of the fixed jaw defines an opening for receiving the punch head.

15. The Locking Pliers with Fall Arrest Anchoring Device of claim 13, wherein the punch head projects from the proximal end of the fixed jaw, and the proximal end of the moveable jaw defines an opening for receiving the punch head.

16. The Locking Pliers with Fall Arrest Anchoring Device of claim 13, wherein the punch head projects from the distal end of the fixed jaw, and the distal end of the moveable jaw defines an opening for receiving the punch head.
